(19) United States
(12) Patent Application Publication
(10) Pub. No.: US 2019/0260278 A1
(43) Pub. Date: Aug. 22, 2019

(54) Mobile Apparatus Having Linear Actuator Generating Both Vibration and Sound

(71) Applicant: EM-TECH Co., Ltd, Busan (KR)

(72) Inventors: Cheon Myeong Kim, Gyeongsangnam-do (KR); Sung Chul Jung, Gyeongsangnam-do (KR); Seul Ki Nam, Gyeongsangnam-do (KR); Min Chul Kang, Gyeongsangnam-do (KR)

(21) Appl. No.: 16/280,904

(22) Filed: Feb. 20, 2019

(30) Foreign Application Priority Data
Feb. 21, 2018 (KR) 10-2018-0020427

(51) Int. Cl. H02K 33/18

(52) U.S. Cl. CPC H02K 33/18; H02K 33/16

(57) ABSTRACT

A mobile apparatus has a linear actuator configured to generate vibration and sound, and further includes: a display panel; a frame; and a linear actuator arranged on the frame and configured to vibrate at 50 to 300 Hz to generate a vibration signal or to vibrate at 50 to 20000 Hz to generate a sound signal. The frame encompasses a case for defining the external appearance with the display and an inner bracket on which electronic parts are to be arranged. As compared with a linear actuator that excites a display panel to generate only sound, the linear actuator that performs the vibration function should provide a strong vibration power, which may damage the display panel. This is the reason why the linear actuator is arranged on the frame, not on the display panel.

### TECHNICAL FIELD

The present invention relates to a mobile apparatus having a linear actuator generating both vibration and sound.

### BACKGROUND

A flat panel speaker is used in an apparatus such as a mobile phone, a personal digital assistant (PDA) or a personal computer (PC), and it employs, as a diaphragm, a transparent (flat) panel disposed on the surface of the apparatus to cover a display surface of a display device such as a liquid crystal display device.

FIG. 1 shows an example of a conventional flat panel speaker disclosed in Japan Patent Application Publication 2004-104327, wherein a panel 21 equipped with an actuator 10 is disposed on a surface of a mobile phone, with its edges secured to a case 22 of the mobile phone. Here, a gasket 23 is fitted between the edges of the panel 21 and the case 22 on the whole periphery, and the panel 21 is supported on the case 22 through the gasket 23. In FIG. 1, reference numerals 24 and 25 denote a printed circuit board and a lead wire for connecting the actuator 10 to the printed circuit board 24, respectively. Although not illustrated, for example, a liquid crystal display device is mounted on the printed circuit board 24 as a display device.

In the flat panel speaker with the aforementioned construction, an audio signal is input to the actuator 10, which causes piezoelectric diaphragms 11 and 12 to vibrate, such vibration is transferred to the panel 21 through a holder 13 in the form of waves, and sound is emitted through the entire panel 21. The gasket 23 fitted between the panel 21 and the case 22 serves to decrease the vibration transferred to the case 22 and increase the amount of vibration of the panel 21.

However, the piezoelectric type speaker has advantages such as a reduced thickness, but still has disadvantages such as low flatness of a sound pressure caused by a low damping rate and a small volume of sound.

To solve the foregoing problem, a flat panel speaker used for a large panel includes a dynamic actuator using an electromagnetic force, instead of a piezoelectric device. FIG. 2 shows another example of the conventional flat panel speaker disclosed in Korea Patent Application Publication 2018-0003372. In the actuator of the flat panel speaker in FIG. 2 that generates sound, a lower plate 31 is secured to a support hole 41 formed in a cover bottom 40, and a magnet 32 which is an annular permanent magnet is disposed on the outer periphery of the lower plate. An upper plate 31′ is disposed on the magnet 32, and an external frame 34 is disposed on the outer periphery of the upper plate, projecting from the upper plate. In addition, a center pole 33 is disposed in a center region of the lower plate 31 in a projecting manner, and a bobbin 35 is disposed to surround the center phone 33.

A coil 36 is wound around the lower portion of the bobbin 35, and a current for generating sound is applied to the coil. Further, a damper 37 may be disposed between part of the upper portion of the bobbin and the external frame 34.

The lower plate 31 and the upper plate 31′ support the magnet 32 while securing the actuator 30 for generating sound to the cover bottom 40. In turn, as the lower plate 31 and the upper plate 31′ are coupled to the cover bottom 40, the magnet 32 positioned between the lower plate 31 and the upper plate 31′ can be fixedly supported.

The leading end of the bobbin 35 contacts the rear surface of the display panel 50, which causes the display panel 50 to vibrate, depending on the application state of the current, and such vibration generates a sound wave.

However, the bobbin 35 needs to be attached to the display panel 50, which complicates the assembly process. There is also a disadvantage such as low applicability to a small apparatus such as a mobile phone.

### SUMMARY

An object of the present invention is to provide a mobile apparatus having a linear actuator for generating a strong vibration power to provide both a vibration function and a sound function.

According to an aspect of the present invention for achieving the above object, there is provided a mobile apparatus having a linear actuator generating vibration and sound, including: a display panel and a frame; and a linear actuator arranged on the frame of the mobile apparatus to vibrate at 50 to 300 Hz to generate a sensible vibration signal or to vibrate at 50 to 20000 Hz to generate a sound signal. Here, the frame encompasses a case for defining the external appearance with the display and an inner bracket on which electronic parts are to be arranged. As compared with a linear actuator that excites a display panel to generate only sound, the linear actuator that performs the vibration function should provide a strong vibration power, which may damage the display panel. This is the reason why the linear actuator is arranged on the frame, not on the display panel.

In some embodiments, the linear actuator may include a casing, a plurality of stators attached in the casing, a plurality of vibrators vibrating vertically due to a mutual electromagnetic force with the respective stators, a nonmagnetic body for securing the plurality of vibrators, and an elastic member arranged in the casing to guide the vibration of the body. Since the linear actuator should generate a strong vibration power to provide both a vibration function and a sound function, the plural pairs of stators and vibrators form one actuator.

In some embodiments, the body may further include a dummy mass.

In some embodiments, the stators may be flat coils and the vibrators may be permanent magnets.

In some embodiments, the stators may be permanent magnets and the vibrators may be flat coils.

In some embodiments, the vibrator may include a yoke coupled to the body and a permanent magnet attached on the yoke, and the stator may be a voice coil disposed in an air gap between the yoke and the permanent magnet.

In some embodiments, the plurality of voice coils may be alternately attached to the top and bottom surfaces of the casing, and the yokes and the permanent magnets of the vibrators may be disposed on the body, corresponding to the surfaces to which the voice coils are attached.

In some embodiments, the stator may include a pole piece and a coil wound around the pole piece, and the vibrator may be a ring-shaped permanent magnet surrounding the stator with a spacing from the stator.

In some embodiments, the elastic member may be disposed at one side of the body.

In some embodiments, the elastic members may be disposed at both sides of the body.

In some embodiments, the elastic members may be disposed at both ends of the body.

In some embodiments, the elastic members may be disposed between both ends of the body and the respective stators.

In some embodiments, the elastic members may be disposed between the respective vibrators and the casing.

The mobile apparatus having the linear actuator as disclosed herein has an advantage in that it can provide both the vibration function and the sound function through the linear actuator, without needing to separately have a speaker module and a vibration module.

Those skilled in the art will recognize additional features and advantages upon reading the following detailed description, and upon viewing the accompanying drawings.

### BRIEF DESCRIPTION OF THE DRAWINGS

FIG. 1 shows an example of a conventional flat panel speaker.

FIG. 2 shows another example of the conventional flat panel speaker.

FIG. 3 schematically shows a mobile apparatus having a linear actuator according to one embodiment of the present invention.

FIG. 4 schematically shows a mobile apparatus having a linear actuator according to another embodiment of the present invention.

FIG. 5 is an exploded view showing a linear actuator provided in a mobile apparatus according to a first embodiment of the present invention.

FIG. 6 is a sectional view showing the linear actuator provided in the mobile apparatus according to the first embodiment of the present invention.

FIG. 7 is an exploded view showing a linear actuator provided in a mobile apparatus according to a second embodiment of the present invention.

FIG. 8 is a sectional view showing the linear actuator provided in the mobile apparatus according to the second embodiment of the present invention.

FIG. 9 is an exploded view showing a linear actuator provided in a mobile apparatus according to a third embodiment of the present invention.

FIG. 10 is a sectional view showing the linear actuator provided in the mobile apparatus according to the third embodiment of the present invention.

FIG. 11 is an exploded view showing a linear actuator provided in a mobile apparatus according to a fourth embodiment of the present invention.

FIG. 12 is a sectional view showing the linear actuator provided in the mobile apparatus according to the fourth embodiment of the present invention.

FIG. 13 is an exploded view showing a linear actuator provided in a mobile apparatus according to a fifth embodiment of the present invention.

FIG. 14 is a sectional view showing the linear actuator provided in the mobile apparatus according to the fifth embodiment of the present invention.

FIG. 15 is a sectional view showing a linear actuator provided in a mobile apparatus according to a sixth embodiment of the present invention.

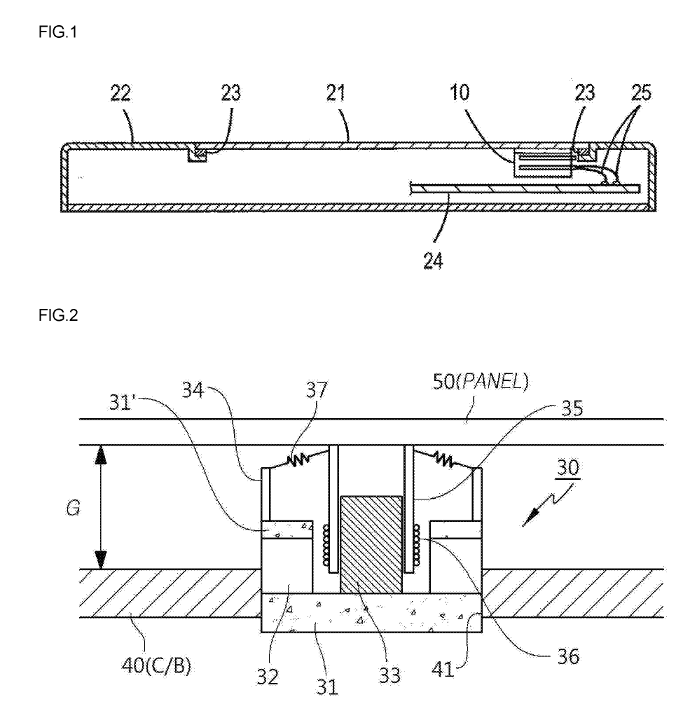

### DETAILED DESCRIPTION

Hereinafter, preferred embodiments of a mobile apparatus having a linear actuator generating both vibration and sound according to the present invention will be described in detail with reference to the accompanying drawings.

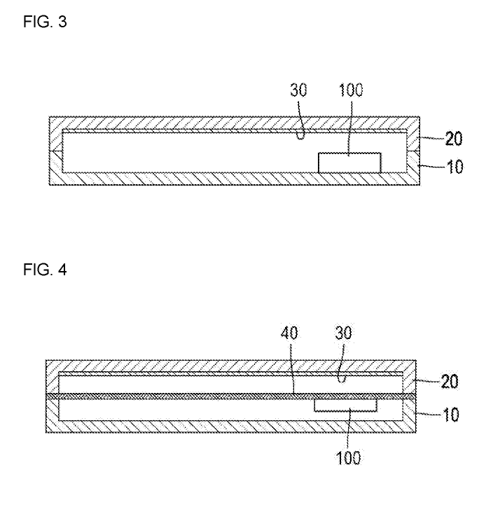

FIG. 3 schematically shows a mobile apparatus having a linear actuator according to one embodiment of the present invention. The mobile apparatus includes a case 10 for defining the external appearance, a display panel 30 for providing visual effects to the user, and a tempered glass 20 for protecting the display panel 30, a linear actuator 100 being arranged in the case 10.

FIG. 4 schematically shows a mobile apparatus having a linear actuator according to another embodiment of the present invention. The mobile apparatus includes a case 10 for defining the external appearance, a display panel 30 for providing visual effects to the user, a tempered glass 20 for protecting the display panel 30, and an inner bracket 40 on which electronic parts are to be arranged.

The linear actuator according to the present invention generates a strong vibration power, wherein it vibrates at 50 to 300 Hz to generate a sensible vibration signal that can be sensed by the user and vibrates at 50 to 20000 Hz to generate a sound signal. Since the strong vibration signal that can be sensed by the user is generated, the linear actuator 100 is arranged on the frame 10 and 40, not on the display panel 30 which may be damaged by vibration. Here, the frame 10 and 40 encompasses the case 10 for defining the external appearance and the inner bracket 40 on which electronic parts are to be arranged. As compared with the linear actuator that excites the display panel 30 to generate only sound, the linear actuator that performs a vibration function should provide a strong vibration power, which may damage the display panel 30. This is the reason why the linear actuator 100 is arranged on the frame 10 and 40, not on the display panel 30.

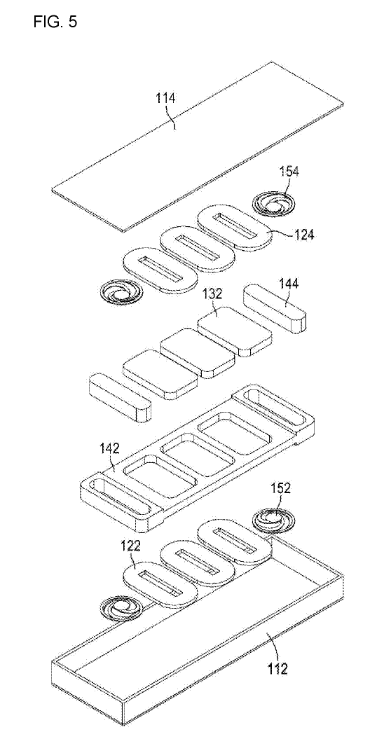

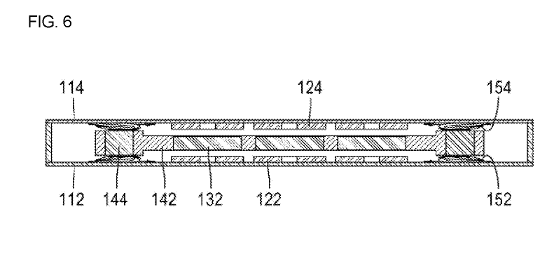

FIG. 5 is an exploded view showing a linear actuator provided in a mobile apparatus according to a first embodiment of the present invention and FIG. 6 is a sectional view showing the linear actuator provided in the mobile apparatus according to the first embodiment of the present invention.

In the linear actuator provided in the mobile apparatus according to the first embodiment of the present invention, components are arranged in a casing formed by coupling a lower casing 112 having a bottom surface and sidewalls and an upper casing 114 defining a top surface. A plurality of flat coils 122 and 124 that form stators are attached to the inner surfaces of the lower casing 112 and the upper casing 114, i.e., the top surface of the lower casing 112 and the bottom surface of the upper casing 114. The flat coils 122 and 124 attached to the lower casing 112 and the upper casing 114 are attached in pairs, and the coils that form a pair are arranged on the same Z axis. In the first embodiment of the present invention, there are three pairs of flat coils 122 and 124, but there may be two or four pairs of flat coils 122 and 124 as well. Although not illustrated, a PCB or wire for transferring a signal to the coils 122 and 124 may be arranged on the inner surface of the casing 112 and 114.

A permanent magnet 132 is disposed on the same axis as that of the flat coils 122 and 124 as a vibrator for generating a mutual electromagnetic force with the flat coils 122 and 124. The number of the permanent magnets 132 is the same as the number of the pairs of the flat coils 122 and 124, i.e., three. In addition, a nonmagnetic body 142 is provided to fixedly incorporate the permanent magnets 132 to realize a consistent behavior when the permanent magnets 132 vibrate vertically due to the mutual electromagnetic force with the flat coils 122 and 124. A nonmagnetic and inexpensive high-mass SUS material is used as the body 142, but any kind of nonmagnetic materials may be used. Dummy masses 144 may be further provided at both ends of the body 142 to increase the mass of the vibrator to enhance the vibration power. The plurality of permanent magnets 132, the body 142 and the dummy masses 144 may be regarded as a vibrating body as a whole. In the first embodiment of the present invention, the dummy masses 144 are disposed at both ends of the body 142, but may be disposed at the center of the body 142, if need be.

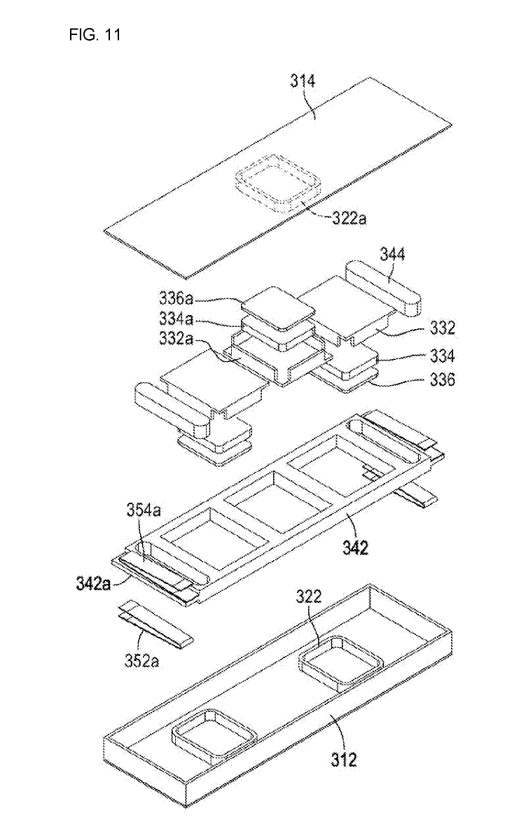

Moreover, elastic members 152 and 154 for elastically supporting the vibrating body may be interposed between the vibrating body and the casing 112 and 114. Preferably, the elastic members 152 and 154 may be arranged at both ends of the vibrating body, in which case there is an advantage of preventing the vibrating body from being tilted while vibrating. In the first embodiment of the present invention, a spring having an outer circumference attached to the casing 112 and 114 and having a center attached to the vibrating body, with a plurality of bridges provided between the center and the outer circumference, is used as the elastic member 152 and 154. In addition, the elastic members 152 and 154 are provided on the upper and lower sides of both ends of the vibrating body, respectively, such that the number of the elastic members 152 and 154 is four. However, two elastic members 152 may be provided only at the lower sides of both ends of the vibrating body, or two elastic members 154 may be provided only at the upper sides of both ends of the vibrating body. Further, the elastic members may be formed as V-shaped strips with a bent portion, not in a circular shape (see FIG. 11). That is, the shape, number and position of the elastic members may vary as desired. It is thus possible to adjust the shape, number and position of the elastic members to decide the resonance frequency of the linear actuator.

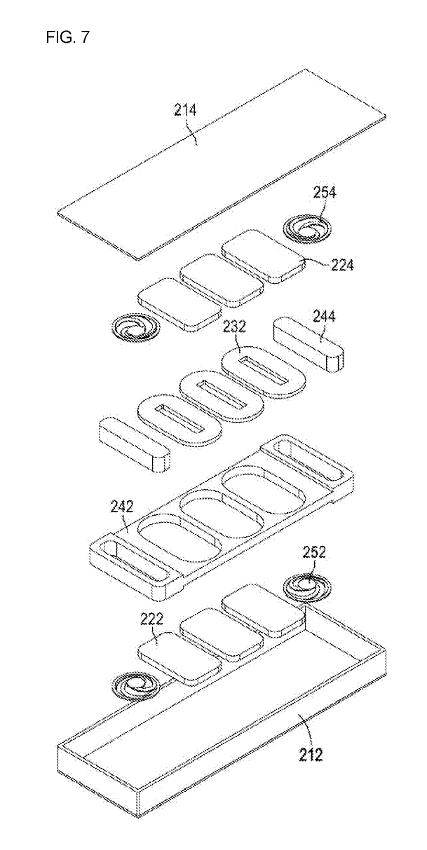

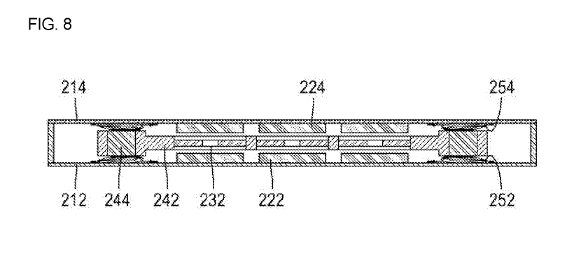

FIG. 7 is an exploded view showing a linear actuator provided in a mobile apparatus according to a second embodiment of the present invention, and FIG. 8 is a sectional view showing the linear actuator provided in the mobile apparatus according to the second embodiment of the present invention. The linear actuator according to the second embodiment of the present invention is the same as the linear actuator according to the first embodiment, except that flat coils 232 are used as vibrators and permanent magnets 222 and 224 are used as stators.

In the linear actuator provided in the mobile apparatus according to the second embodiment of the present invention, components are arranged in a casing formed by coupling a lower casing 212 having a bottom surface and sidewalls and an upper casing 214 defining a top surface. A plurality of permanent magnets 222 and 224 that form stators are attached to the inner surfaces of the lower casing 212 and the upper casing 214, i.e., the top surface of the lower casing 212 and the bottom surface of the upper casing 214. The permanent magnets 222 and 224 attached to the lower casing 212 and the upper casing 214 are attached in pairs, and the permanent magnets that form a pair are arranged on the same Z axis. In the second embodiment of the present invention, there are three pairs of permanent magnets 222 and 224, but there may be two or four pairs of permanent magnets 222 and 224 as well.

A flat coil 232 is disposed on the same axis as that of the permanent magnets 222 and 224 as a vibrator for generating a mutual electromagnetic force. The number of the flat coils 232 is the same as the number of the pairs of the permanent magnets 222 and 224, i.e., three. In addition, a nonmagnetic body 242 is provided to fixedly incorporate the flat coils 232 to realize a consistent behavior when the flat coils 232 vibrate vertically due to the mutual electromagnetic force with the permanent magnets 222 and 224. A nonmagnetic and inexpensive high-mass SUS material is used as the body 242, but any kind of nonmagnetic materials may be used. Dummy masses 244 may be further provided at both ends of the body 242 to increase the mass of the vibrator to enhance the vibration power. The plurality of flat coils 232, the body 242 and the dummy masses 244 may be regarded as a vibrating body as a whole.

Moreover, elastic members 252 and 254 for elastically supporting the vibrating body may be interposed between the vibrating body and the casing 212 and 214. Preferably, the elastic members 252 and 254 may be arranged at both ends of the vibrating body, in which case there is an advantage of preventing the vibrating body from being tilted while vibrating. In the second embodiment of the present invention, a spring having an outer circumference attached to the casing 212 and 214 and having a center attached to the vibrating body, with a plurality of bridges provided between the center and the outer circumference, is used as the elastic member 252 and 254. In addition, the elastic members 252 and 254 are provided on the upper and lower sides of both ends of the vibrating body, respectively, such that the number of the elastic members 252 and 254 is four. However, two elastic members 252 may be provided only at the lower sides of both ends of the vibrating body, or two elastic members 254 may be provided only at the upper sides of both ends of the vibrating body. Further, the elastic members 252 and 254 may be formed as V-shaped strips with a bent portion, not in a circular shape (see FIG. 11). That is, the shape, number and position of the elastic members 252 and 254 may vary as desired. It is thus possible to adjust the shape, number and position of the elastic members 252 and 254 to decide the resonance frequency of the linear actuator.

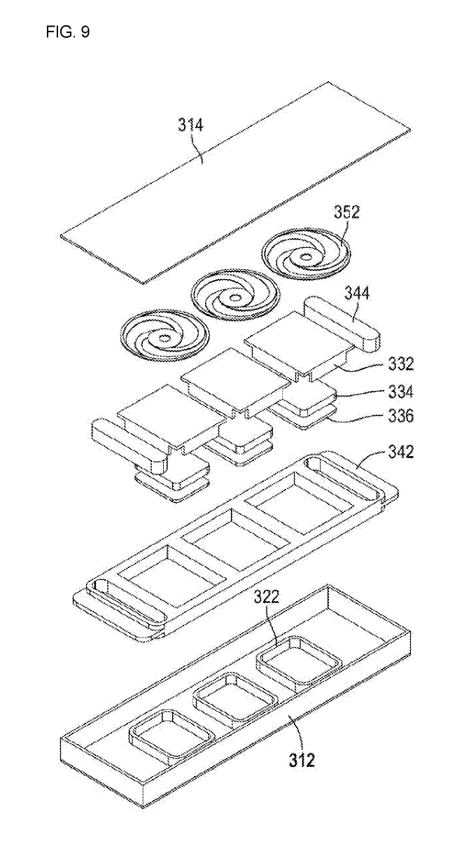

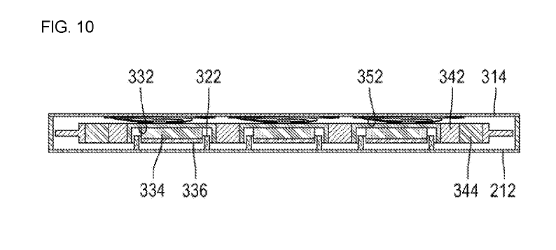

FIG. 9 is an exploded view showing a linear actuator provided in a mobile apparatus according to a third embodiment of the present invention, and FIG. 10 is a sectional view showing the linear actuator provided in the mobile apparatus according to the third embodiment of the present invention.

In the linear actuator provided in the mobile apparatus according to the third embodiment of the present invention, components are arranged in a casing formed by coupling a lower casing 312 having a bottom surface and sidewalls and an upper casing 314 defining a top surface. A plurality of voice coils 322 that form stators are attached to the bottom surface of the lower casing 112. In the third embodiment of the present invention, there are three voice coils 322, but there may be two or four or more voice coils 322 as well.

A magnetic circuit composed of a yoke 332, a permanent magnet 334 and a top plate 336 is disposed on the same axis as that of the voice coil 322 as a vibrator for generating a mutual electromagnetic force. The permanent magnet 334 is attached to the yoke 332, and the top plate 336 is attached to the permanent magnet 334. The yoke 332 has a top surface to which the permanent magnet 334 is attached and side surfaces downwardly bent from the top surface. The top surface of the yoke 332 is larger than the area of the permanent magnet 334, such that there is an air gap between the side surfaces of the yoke 332 and the permanent magnet 334. The upper end of the voice coil 322 is positioned in the air gap between the yoke 332 and the permanent magnet 334, as a result of which, when a signal is transferred to the voice coil 322, the vibrator vibrates due to the mutual electromagnetic force. The number of the magnetic circuits 332, 334 and 336 is the same as the number of the voice coils 322, i.e., three.

In addition, a nonmagnetic body 342 is provided to fixedly incorporate the plurality of magnetic circuits 332, 334 and 336 to realize a consistent behavior when the magnetic circuits 332, 334 and 336 vibrate vertically due to the mutual electromagnetic force with the voice coils 322. A nonmagnetic and inexpensive high-mass SUS material is used as the body 342, but any kind of nonmagnetic materials may be used. Dummy masses 344 may be further provided at both ends of the body 342 to increase the mass of the vibrator to enhance the vibration power. The plurality of magnetic circuits 332, 334 and 336, the body 342 and the dummy masses 344 may be regarded as a vibrating body as a whole.

Moreover, elastic members 352 for elastically supporting the vibrating body may be interposed between the vibrating body and the upper casing 314. In the third embodiment of the present invention, the elastic members 352 are interposed between each vibrator and the upper casing 314, such that the number of the elastic members 352 is three. A spring having an outer circumference attached to the upper casing 314 and having a center attached to the yoke 332, with a plurality of bridges provided between the center and the outer circumference, is used as the elastic member 352. However, four elastic members may be provided on the upper and lower sides of both ends of the vibrating body, respectively, two elastic members may be provided only at the lower sides of both ends of the vibrating body, or two elastic members may be provided only at the upper sides of both ends of the vibrating body. Further, the elastic members may be formed as V-shaped strips with a bent portion, not in a circular shape (see FIG. 11). That is, the shape, number and position of the elastic members may vary as desired. It is thus possible to adjust the shape, number and position of the elastic members to decide the resonance frequency of the linear actuator.

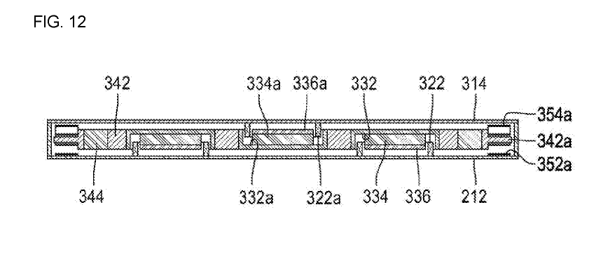

FIG. 11 is an exploded view showing a linear actuator provided in a mobile apparatus according to a fourth embodiment of the present invention, and FIG. 12 is a sectional view showing the linear actuator provided in the mobile apparatus according to the fourth embodiment of the present invention.

The linear actuator provided in the mobile apparatus according to the fourth embodiment of the present invention includes the same magnetic circuit as that of the linear actuator according to the third embodiment of the present invention, except that voice coils 322 and 322a are alternately attached to a lower casing 312 and an upper casing 314, which results in a different method of arranging the magnetic circuit. Also, elastic members 352a and 354a are different in position and shape from those of the third embodiment.

The linear actuator provided in the mobile apparatus according to the fourth embodiment of the present invention includes three voice coils 322 and 322a and three magnetic circuits 332, 332a, 334, 334a, 336 and 336a. The voice coils 322 positioned at both sides are attached to the lower casing 312 as in the third embodiment. In addition, in the magnetic circuits 332, 334 and 336 that interact with the voice coils 322 positioned at both sides, the yoke 332 has a top surface to which the permanent magnet 334 is attached and side surfaces downwardly bent from the top surface, as in the third embodiment.

However, the voice coil 322a positioned at the center is attached to the upper casing 314, and the yoke 332a has a bottom surface and side surfaces upwardly bent from the bottom surface, unlike the yokes 332 positioned at both sides. The permanent magnet 334a is attached on the yoke 332a, and the top plate 336a is attached on the permanent magnet 334a.

According to the fourth embodiment of the present invention, when there are two voice coils 322 and 322a and two magnetic circuits 332, 332a, 334, 334a, 336 and 336a, the voice coils 322 and 322a may be alternately positioned at the upper side and the lower side, and when there are four or more voice coils 322 and 322a and four or more magnetic circuits 332, 332a, 334, 334a, 336 and 336a, the voice coils 322 and 322a may be alternately positioned at the upper side, lower side, upper side, and lower side.

In addition, a nonmagnetic body 342 is provided to fixedly incorporate the plurality of magnetic circuits 332, 332a, 334, 334a, 336 and 336a to realize a consistent behavior when the magnetic circuits 332, 332a, 334, 334a, 336 and 336a vibrate vertically due to the mutual electromagnetic force with the voice coils 322 and 322a. A nonmagnetic and inexpensive high-mass SUS material is used as the body 342, but any kind of nonmagnetic materials may be used. Dummy masses 344 may be further provided at both ends of the body 342 to increase the mass of the vibrator to enhance the vibration power. The plurality of magnetic circuits 332, 332a, 334, 334a, 336 and 336a, the body 342 and the dummy masses 344 may be regarded as a vibrating body as a whole.

Moreover, elastic members 352a and 354a for elastically supporting the vibrating body may be interposed between the vibrating body and the upper casing 314. In the fourth embodiment of the present invention, the elastic members 352a and 354a are interposed between the body 342 and the casing 312 and 314, such that the number of the elastic members 352a and 354a is four. Further, the elastic members 352a and 354a are springs formed as V-shaped strips with a bent portion. In order to facilitate the positioning of the V-shaped elastic members 352a and 354a, the body 342 may include elastic member supports 342a outside the dummy masses 344. Two elastic members 352a may be provided only at the lower sides of both ends of the vibrating body, or two elastic members 354a may be provided only at the upper sides of both ends of the vibrating body. That is, the shape, number and position of the elastic members may vary as desired. It is thus possible to adjust the shape, number and position of the elastic members to decide the resonance frequency of the linear actuator.

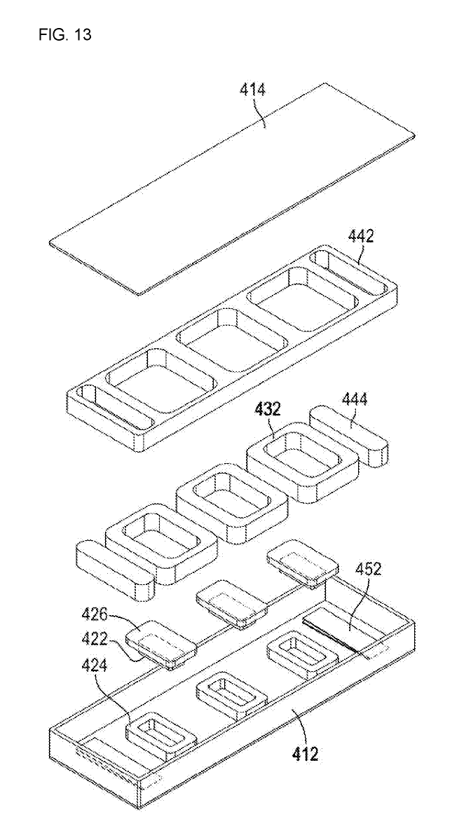

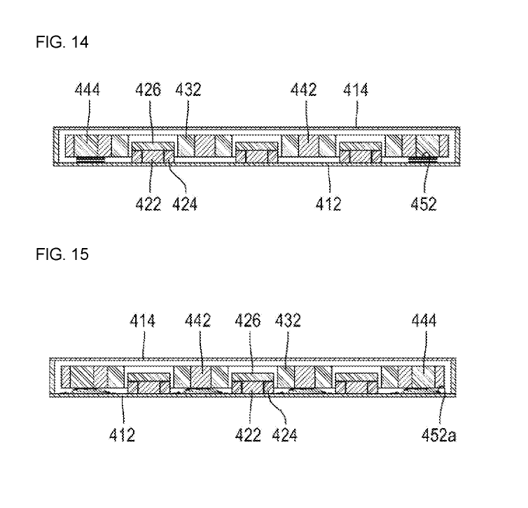

FIG. 13 is an exploded view showing a linear actuator provided in a mobile apparatus according to a fifth embodiment of the present invention, and FIG. 14 is a sectional view showing the linear actuator provided in the mobile apparatus according to the fifth embodiment of the present invention.

In the linear actuator provided in the mobile apparatus according to the fifth embodiment of the present invention, components are arranged in a casing formed by coupling a lower casing 412 having a bottom surface and sidewalls and an upper casing 414 defining a top surface. A plurality of pole pieces 422 that form stators and coils 424 wound around the respective pole pieces 422 are attached to the bottom surface of the lower casing 412. Preferably, a top plate 426 is further attached to the top surfaces of the pole piece 422 and coil 424. In the fifth embodiment of the present invention, there are three stators 422, 424 and 426, but there may be two or four or more stators 422, 424 and 426 as well.

A ring-shaped permanent magnet 432 is disposed on the same axis as that of the stator 422, 424 and 426 with an air gap as a vibrator for generating a mutual electromagnetic force. The number of the permanent magnets 432 is the same as the number of the stators 422, 424 and 426, i.e., three.

In addition, a nonmagnetic body 442 is provided to fixedly incorporate the permanent magnets 432 to realize a consistent behavior when the permanent magnets 432 vibrate vertically due to the mutual electromagnetic force with the stators 422, 424 and 426. A nonmagnetic and inexpensive high-mass SUS material is used as the body 442, but any kind of nonmagnetic materials may be used. Dummy masses 444 may be further provided at both ends of the body 442 to increase the mass of the vibrator to enhance the vibration power. The plurality of permanent magnets 432, the body 442 and the dummy masses 444 may be regarded as a vibrating body as a whole.

Moreover, elastic members 452 for elastically supporting the vibrating body may be interposed between the vibrating body and the lower casing 412. In the fifth embodiment of the present invention, the elastic members 452 are interposed between both ends of the vibrating body and the lower casing 412, such that the number of the elastic members 452 is two. However, four elastic members may be provided on the upper and lower sides of both ends of the vibrating body, respectively, or two elastic members may be provided only at the upper sides of both ends of the vibrating body. Also in the fifth embodiment, springs formed as V-shaped strips with a bent portion are used, but a variety of springs such as leaf springs or spiral springs may be used. That is, the shape, number and position of the elastic members may vary as desired. It is thus possible to adjust the shape, number and position of the elastic members to decide the resonance frequency of the linear actuator.

FIG. 15 is a sectional view showing a linear actuator provided in a mobile apparatus according to a sixth embodiment of the present invention. The shape and position of the components of the sixth embodiment of the present invention are the same as those of the fifth embodiment, except for the shape, number and position of the elastic members.

In the sixth embodiment of the present invention, an elastic member 452a is a spring having an outer circumference attached to a lower casing 412 and having a center attached to a vibrating body, with a plurality of elastic bridges provided between the center and the outer circumference. The elastic members 452a are disposed between the vibrating body and the lower casing 412 and disposed between both ends of the vibrating body and stators 422, 424 and 426, such that the number of the elastic members 452a is four. As discussed earlier, the shape, number and position of the elastic members may be adjusted, as desired, to tune the resonance frequency of the linear actuator.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A mobile apparatus having a linear actuator configured to generate vibration and sound, the mobile apparatus comprising:
a display panel;
a frame; and
a linear actuator arranged on the frame and configured to vibrate at 50 to 300 Hz to generate a sensible vibration signal or to vibrate at 50 to 20000 Hz directly to cause the mobile apparatus to vibrate to generate a sound signal.

2. The mobile apparatus of claim 1, wherein the linear actuator comprises a casing, a plurality of stators attached in the casing, a plurality of vibrators vibrating vertically due to a mutual electromagnetic force with the respective stators, a body for securing the plurality of vibrators, and elastic members arranged in the casing to guide the vibration of the body.

3. The mobile apparatus of claim 2, wherein the body further comprises a dummy mass.

4. The mobile apparatus of claim 2, wherein the stators are flat coils and the vibrators are permanent magnets.

5. The mobile apparatus of claim 2, wherein the stators are permanent magnets and the vibrators are flat coils.

6. The mobile apparatus of claim 2, wherein the plurality of vibrators comprises a yoke coupled to the body and a permanent magnet attached on the yoke, and wherein the stator is a voice coil disposed in an air gap between the yoke and the permanent magnet.

7. The mobile apparatus of claim 6, wherein the plurality of voice coils is alternately attached to top and bottom surfaces of the casing, and wherein the yoke and the permanent magnet of the plurality of vibrators are disposed on the body, corresponding to surfaces to which the voice coils are attached.

8. The mobile apparatus of claim 2, wherein the stator comprises a pole piece and a coil wound around the pole piece, and the wherein plurality of vibrators comprises a ring-shaped permanent magnet surrounding the stator with a spacing from the stator.

9. The mobile apparatus of claim 2, wherein the elastic members are disposed at one side of the body.

10. The mobile apparatus of claim 2, wherein the elastic members are disposed at both sides of the body.

11. The mobile apparatus of claim 2, wherein the elastic members are disposed at both ends of the body.

12. The mobile apparatus of claim 2, wherein the elastic members are disposed between both ends of the body and the respective stators.

13. The mobile apparatus of claim 2, wherein the elastic members are disposed between the respective vibrators and the casing.
